(19) United States
(12) Patent Application Publication
(10) Pub. No.: US 2013/0063892 A1
(43) Pub. Date: Mar. 14, 2013

(54) Portable Electronic Device

(71) Applicant: Tien-Hwa Ho, New Taipei City (TW)

(72) Inventor: Tien-Hwa Ho, New Taipei City (TW)

(21) Appl. No.: 13/230,846

(22) Filed: Sep. 13, 2011

(51) Int. Cl. G06F 1/16

(52) U.S. Cl. 361/679.58

(57) ABSTRACT

A portable electronic device comprises a first handheld device and a second handheld device, wherein the first handheld device and the second handheld device can be combined through the connection of a locking unit and a corresponding locking unit and the connection of an electrical-connecting unit and a corresponding electrical-connecting unit, so that the resources in one handheld device can be shared with the other handheld device, whereby the portable electronic device can be carried and operated with ease, scaled with flexibility, and comprised of various functions.

### (a) TECHNICAL FIELD OF THE INVENTION

The present invention relates to a portable electronic device and, more particularly, to a powerful mobile device that can be carried and operated with ease, scaled with flexibility, and comprised of various functions.

### (b) DESCRIPTION OF THE PRIOR ART

Handheld devices or mobile devices have become a widespread technology, almost everyone owns a handheld device. The major manufacturers do their best in the development of newer technologies to meet people's needs and desires. The mobile technology continues to progress from handheld devices with mono-color screen to the current handheld devices with colorful touch-screen. However, these handheld devices are all a device with a screen, a battery, a memory card, and so forth. If a user wishes to expand the capacity of the battery or the memory card, he or she should buy another one with larger capacity to replace the original one. If a user wishes to have two separate numbers for different purposes, he or she should carry phones at the same time, and this may bring inconvenience. Furthermore, the two phones cannot backup for each other.

Currently, there is a handheld device, commonly known as “Dual SIM Dual Standby (RSDS)”, which contains two SIM cards being active simultaneously, so that a user can use one handheld device of the type to operate two separate numbers at the same time without requiring to carry two different devices. However, when one SIM card is busy, the other one will not be reachable.

Thus, there is a need for further improvement on the existing handheld devices to allow a device to be operated on two different numbers at the same time and be carried with ease.

### SUMMARY OF THE INVENTION

The primary object of the present invention is to provide a portable electronic device that includes two individual handheld devices so that it can be operated on two separate numbers at the same time and can be carried with ease.

To achieve the object, the portable electronic device according to the present invention comprises a first handheld device and a second handheld device. The first handheld device is provided with a locking unit and an electrical-connecting unit on a periphery thereof. The second handheld device is provided with a corresponding locking unit and a corresponding electrical-connecting unit on a periphery thereof, wherein the corresponding locking unit of the second handheld device is capable of interlocking with the locking unit of the first handheld device, the corresponding electrical-connecting unit of the second handheld device is capable of electrically connecting with the electrical-connecting unit of the first handheld device, so that the resources in the handheld devices can cooperate with each other. Thereby, the portable electronic device can be installed with two separate SIM cards, which can respectively connect with two mobile service providers at the same time, so that the portable electronic device can operate on two separate numbers at the same time. On the other hand, the portable electronic device can be formed into an integral device through the combination of the two handheld devices for ease of portability, whereby the resource in one handheld device can be shared with the other handheld device.

Other objects, advantages, and novel features of the present invention will become more apparent from the following detailed description when taken in conjunction with the accompanying drawings.

### BRIEF DESCRIPTION OF THE DRAWINGS

FIG. 1 is a 3-dimensional view according to a preferred embodiment of the present invention.

FIG. 2 is an exploded view according to the preferred embodiment of the present invention.

FIG. 2A is a schematic view for showing contacts of the third electrical-connecting port according to the present invention.

FIG. 3 is a schematic view according to another preferred embodiment of the present invention.

FIG. 3A is an enlarged view of a portion of FIG. 3.

FIG. 3B is an enlarged view of a portion of FIG. 3.

FIG. 4 is a schematic diagram according to the present invention.

FIG. 5 shows a first exemplary application according to the present invention.

FIG. 6 shows a second exemplary application according to the present invention.

FIG. 7 shows a third exemplary application according to the present invention.

FIG. 8 shows an operation of a fourth exemplary application according to the present invention

FIG. 8A shows another operation of the fourth exemplary application according to the present invention.

FIG. 9 shows a fifth exemplary application according to the present invention.

FIG. 10 shows a condition of a sixth exemplary application according to the present invention.

FIG. 10A shows another condition of a sixth exemplary application according to the present invention.

FIG. 11 shows a seventh exemplary application according to the present invention.

FIG. 12 shows an eighth exemplary application according to the present invention.

FIG. 13 shows a ninth exemplary application according to the present invention.

FIG. 14 shows a tenth exemplary application according to the present invention.

FIG. 15 shows an eleventh exemplary application according to the present invention.

FIG. 16 shows a twelfth exemplary application according to the present invention.

### DETAILED DESCRIPTION OF THE PREFERRED EMBODIMENTS

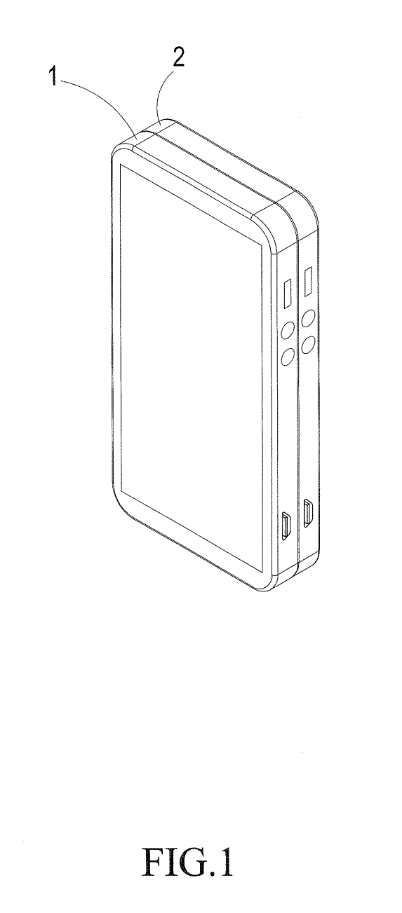

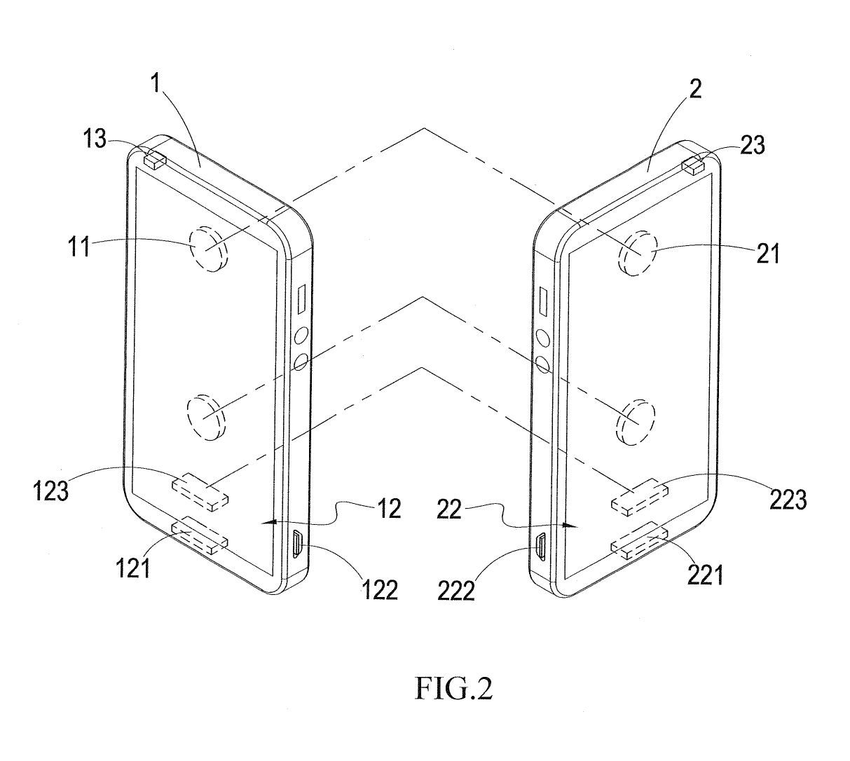

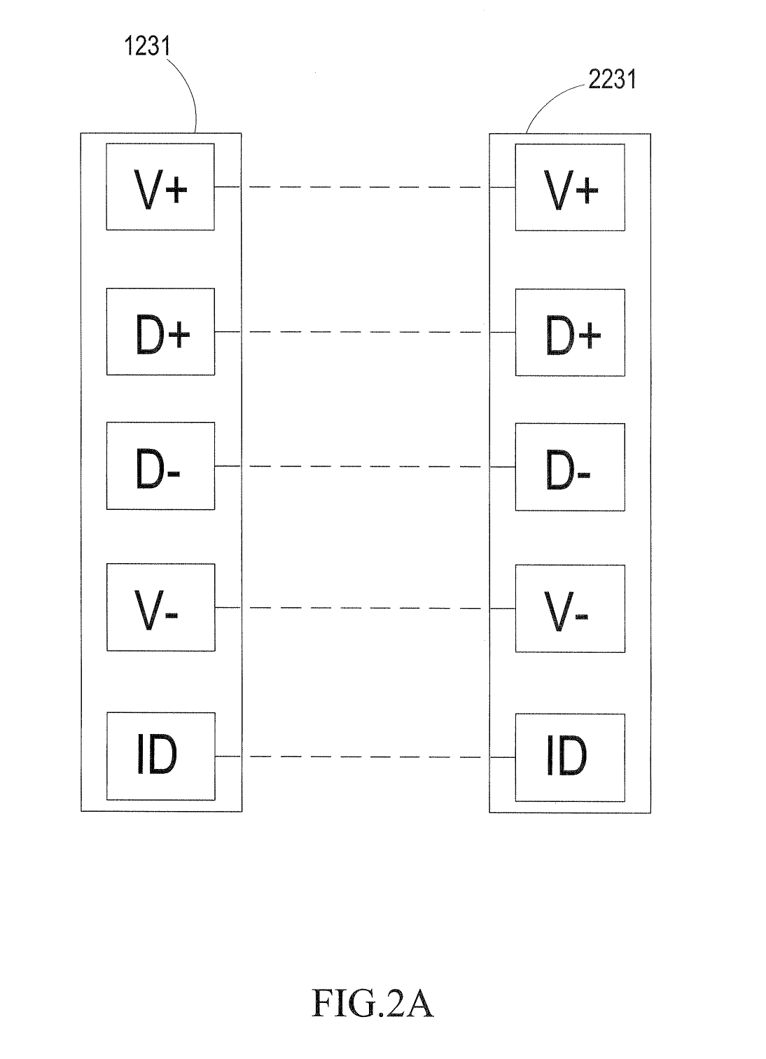

Turning now to FIGS. 1, 2, and 2 A, a preferred embodiment of a portable electronic device according to the present invention generally comprises a first handheld device 1 and a second handheld device 2. The first handheld device 1 is provided with a locking unit 11 and an electrical-connecting unit 12 on a periphery thereof. The first handheld device 1 can be a smartphone, a mobile device, a tablet computer, or the like, wherein the smartphone can run an operating system of Apple iOS, Google android, Microsoft Windows Phone OS, Symbian OS, or the like. Furthermore, the first handheld device 1 contains a built-in wireless module 13, which can connect with other devices without through a base station or a GSM system. The wireless module 13 can be a Wi-Fi module or a wireless ad hoc network module, which cooperates with software in the device to conduct communication. Furthermore, the electrical-connecting unit 12 includes a first electrical-connecting port 121, a second electrical-connecting port 122, and a third electrical-connecting port 123, wherein the first electrical-connecting port 121 can be electrically connected with a computer, the second electrical-connecting port 122 can be electrically connected with a charger, the third electrical-connecting port 123 can be electrically connected with the second handheld device 2 for informational or electrical transfer between the two handheld devices, wherein the third electrical-connecting port 123 contains a plurality of contacts 1231, which include contacts D+, D− for data communication and contacts V+, V− for electrical transfer.

The second handheld device 2 is provided with a corresponding locking unit 21 and a corresponding electrical-connecting unit 22, wherein the corresponding locking unit 21 is employed for interlocking with the locking unit 11 of the first handheld device 1, the corresponding electrical-connecting unit 22 is employed for electrically connecting with the electrical-connecting unit 12 of the first handheld device 1, wherein the second handheld device 2 can be a smartphone, a mobile device, a tablet computer, or the like, wherein the smartphone can run an operating system of Apple iOS, Google android, Microsoft Windows Phone OS, Symbian OS, or the like. In more detail, the locking unit 11 and the corresponding locking unit 21 can be a magnetically attaching means or mechanically engaging means so that the locking unit 11 can be interlocked with the corresponding locking unit 21. Furthermore, the second handheld device 2 contains a built-in wireless module 23, which can be connected with other devices without through a base station or a GSM system. The wireless module 23 can be a Wi-Fi module or a wireless ad hoc network module, which cooperates with software in the device to conduct communication. Furthermore, the corresponding electrical-connecting unit 22 includes a fourth electrical-connecting port 221, a fifth electrical-connecting port 222, and a sixth electrical-connecting port 223, wherein the fourth electrical-connecting port 221 can be electrically connected with a computer, the fifth electrical-connecting port 222 can be electrically connected with a charger, the sixth electrical-connecting port 223 can be electrically connected with the first handheld device 1 for informational or electrical transfer between the two handheld devices, wherein the sixth electrical-connecting port 223 contains a plurality of contacts 2231, which include contacts D+, D− for data communication and contacts V+, V− for electrical transfer.

Furthermore, the electrical-connecting unit 12 and the corresponding electrical-connecting unit 22 each can be formed into an integral unit capable of connecting with a computer, a charger, and the other handheld device.

When the first handheld device 1 is combined with the second handheld device 2, the power sources respectively in the two handheld devices may interconnect to allow one power source to supply electrical energy to the other power source; the software resources, such as an operational interface, a telephone directory, a text message, an application program, or a daily routine, in the handheld devices may cooperate with each other; the hardware resources, such as the storage unit, in one handheld device can be shared with the other handheld device. In other words, data within the storage units of both handheld devices can be shared with and backup for each other. Whenever both handheld devices are combined together, the resources in both handheld devices can be automatically shared with through the informational connection of the third electrical-connecting port 123 and the sixth electrical-connecting port 223. Furthermore, the power sources in both handheld devices can supply power for each other through the electrical connection of the third electrical-connecting port 123 and the sixth electrical-connecting port 223, so that when the first handheld device 1 runs out of electrical power, the second handheld device 2 can supply power for the first handheld device 1.

The first handheld device 1 and the second handheld device 2 can be designed to meet any standards of mobile phones, such as 3G, 3.5 G, 4 G, GSM, CDMA, PHS, TD-CDMA, TD-SCDMA, etc. The first handheld device 1 and the second handheld device 2 each can be installed with a SIM card to be individually connected with a mobile service provider (the mobile service provider for each SIM card may be different), so that both handheld devices 1, 2 can be simultaneously operated by a user.

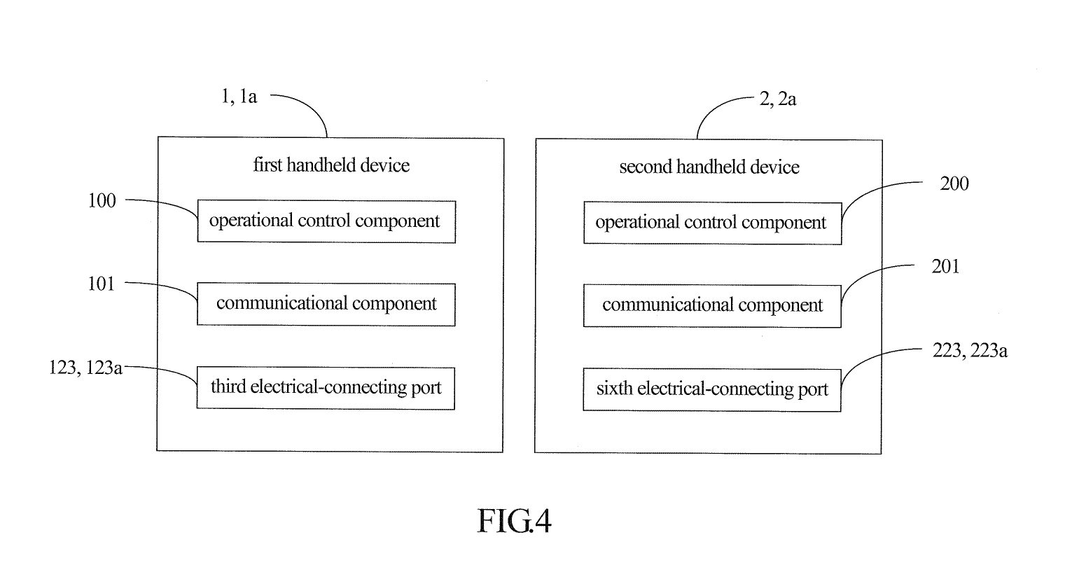

Turning now to FIG. 4, a schematic diagram for illustrating the present invention is shown. In the first handheld device 1, 1a (the numeral 1a represented as another embodiment of the present invention, which will be described in the following), there is an operational control component 100 and a communicational component 101 electrically connected with the operational control component 100. In the second handheld device 2, 2a (the numeral 2a represented as another embodiment of the present invention, which will be described in the following), there is an operational control component 200 and a communicational component 201 electrically connected with the operational control component 200.

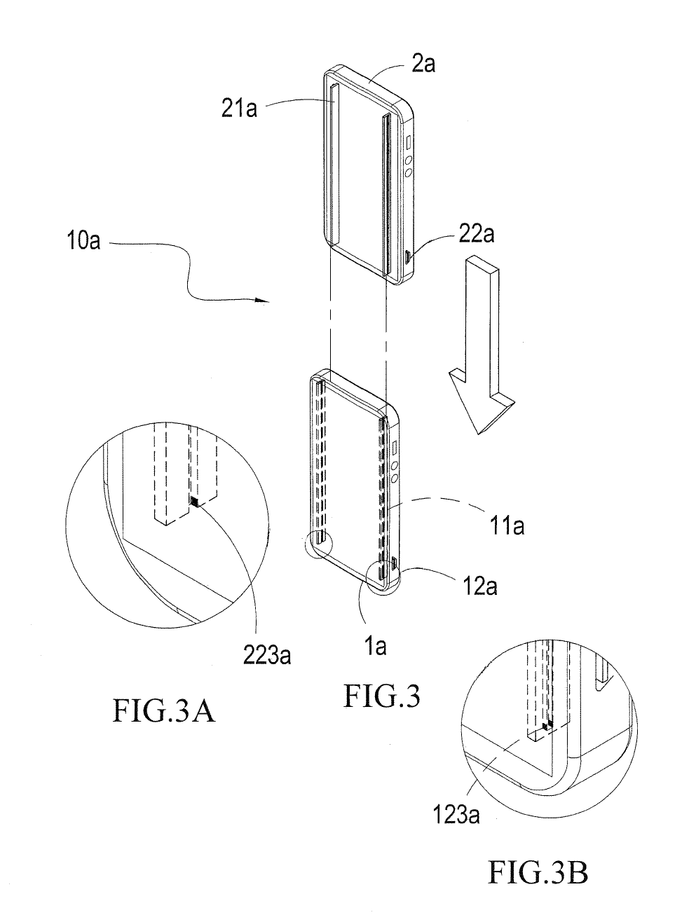

Turning back to FIGS. 3, 3A and 3B, a second preferred embodiment of the portable electronic device according to the present invention is shown. The second embodiment comprises a first handheld device 1a and at least one second handheld device 2a to form an integral assembly 10a of multiple handheld devices, wherein the second handheld device 2a can have a size and a shape substantially the same as the first handheld device 1a, or the second handheld device 2a has a size different from the first handheld device la but has a shape capable of matching with the first handheld device 1a, and wherein the second handheld device 2a can run an operating system substantially the same as the first handheld device 1a. In this embodiment, the first handheld device 1a includes a locking unit 11a and an electrical-connecting unit 12a, wherein the locking unit 12a is formed as a strip member; however, other forms of locking unit, such as magnetically attaching means, can also be applied in this embodiment. Also, the electrical-connecting unit 12a includes a first electrical-connecting port 121 (the same as the first embodiment, not shown in FIG. 3), a second electrical-connecting port 122 (the same as the first embodiment), and a third electrical-connecting port 123a. On the other hand, the second handheld device 2a includes a corresponding locking unit 21a and a corresponding electrical-connecting unit 22a, wherein the corresponding locking unit 22a is formed as a slotted member that can be engaged with the locking unit 12a, being a strip member, of the first handheld device 1a. Also, the corresponding electrical-connecting unit 22a includes a fourth electrical-connecting port 221 (the same as the first embodiment, not shown in FIG. 3), a fifth electrical-connecting port 222 (the same as the first embodiment), and a sixth electrical-connecting port 223a. When the first handheld device 1a is combined with the second handheld device 2a by engaging the locking unit 11a with the corresponding locking unit 21a, the third electrical-connecting port 123a of the first handheld device 1a can electrically connect with the sixth electrical-connecting port 223a of the second handheld device 2a so that informational or electrical connection can be built to respectively achieve the function of informational exchange or power transfer.

Furthermore, the first handheld device 1, 1a can be operated in cooperation with the second handheld device 2, 2a when they are combined together. The first handheld device 1, 1a and the second handheld device 2, 2a can be operated individually when they are taken apart.

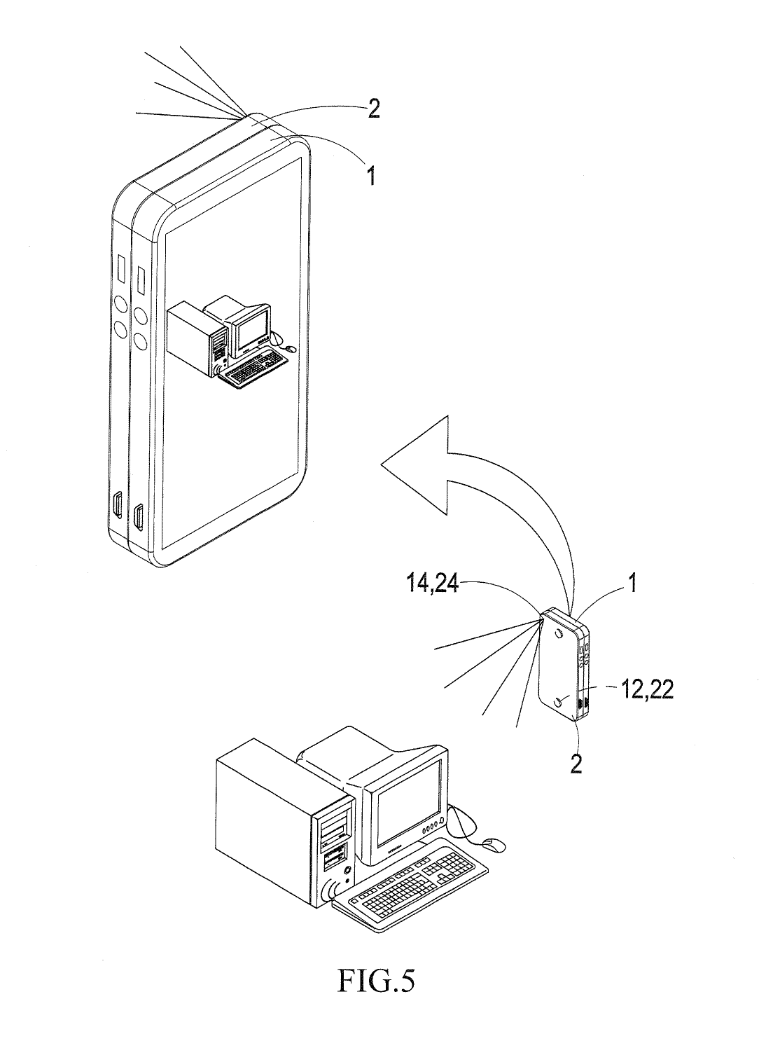

Turning now to FIG. 5, a first exemplary application according to the present invention is shown, wherein the first handheld device 1 and the second handheld device 2 are respectively provided with cameras 14, 24, so that when both handheld devices 1, 2 are combined together, each handheld device can share the information taken from its camera with the other handheld device. In more detail, the second handheld device 2 is provided with a camera 24, when the first handheld device 1 and the second handheld device 2 are combined back by back, the image taken by the camera 24 can be transfer to the first handheld device 1 to show the image on its screen through the informational connection of the electrical-connecting unit 12 and the corresponding electrical-connecting unit 22. Similarly, the screen of the second handheld device 2 can show the image taken from the camera 14 of the first handheld device 1.

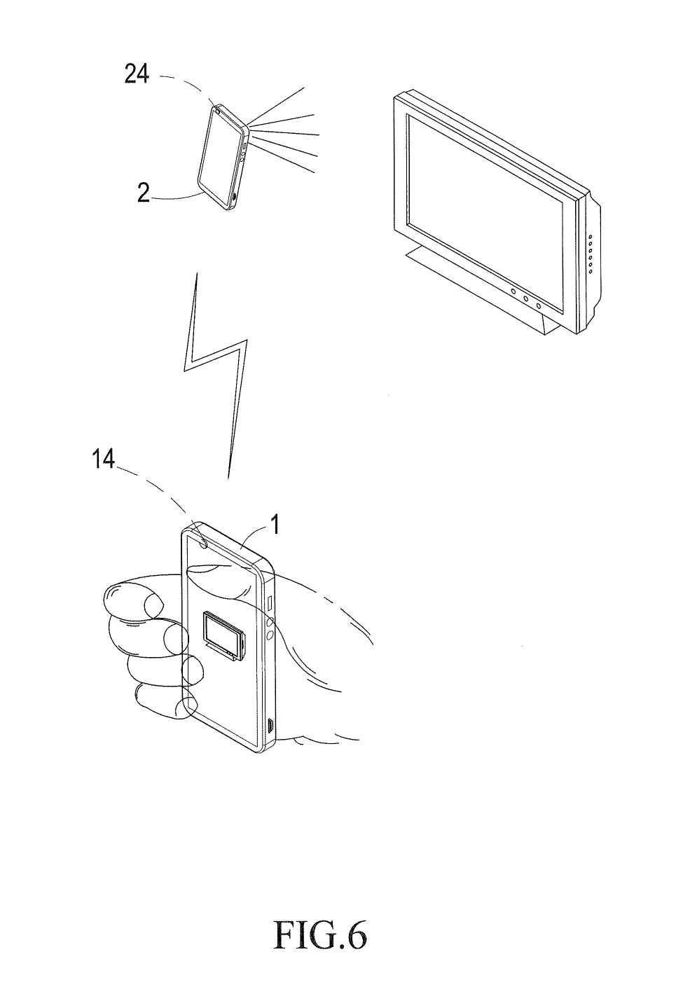

Turning now to FIG. 6, a second exemplary application according to the present invention is shown, wherein when the first handheld device 1 is taken apart from the second handheld device 2, the images of the cameras 14, 24 can be transferred from its original handheld device to the other handheld device through wireless communication. In more detail, the screen of the first handheld device 1 can show the image taken from the camera 24 of the second handheld device 2 through wireless communication; the screen of the second handheld device 2 can show the image taken from the camera 14 of the first handheld device 1 through wireless communication.

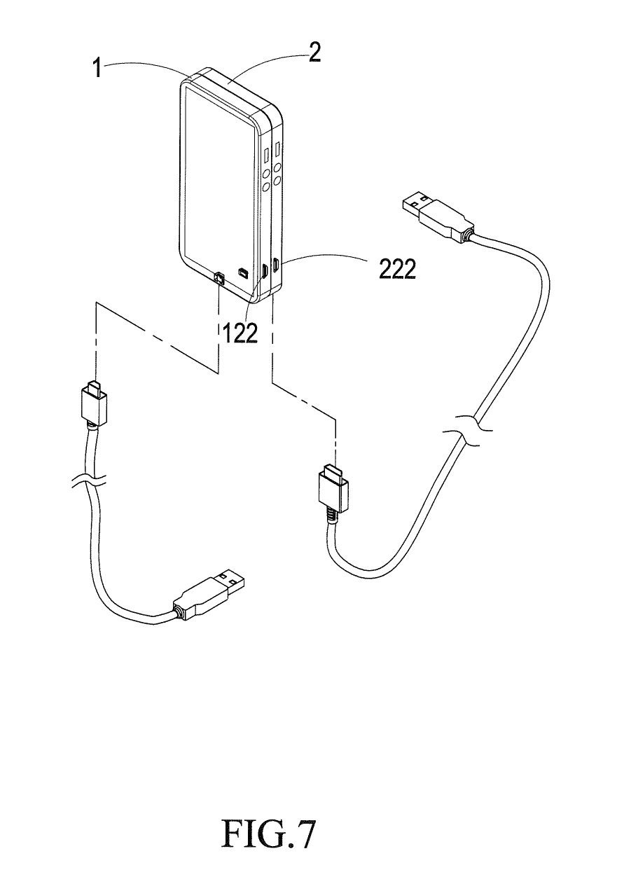

Turning now to FIG. 7, a third exemplary application according to the present invention is shown, wherein the second electrical-connecting port 122 of the first handheld device 1 and the fifth electrical-connecting port 222 of the second handheld device 2 can be a charging port, such as a Micro USB or a Mini USB. The ports of the handheld devices may be different to allow a user to have more options in selecting a charger. In more detail, for example, the second electrical-connecting port 122 of the first handheld device 1 can be a Micro USB port, whereas the fifth electrical-connecting port 222 of the second handheld device 2 can be a Mini USB port.

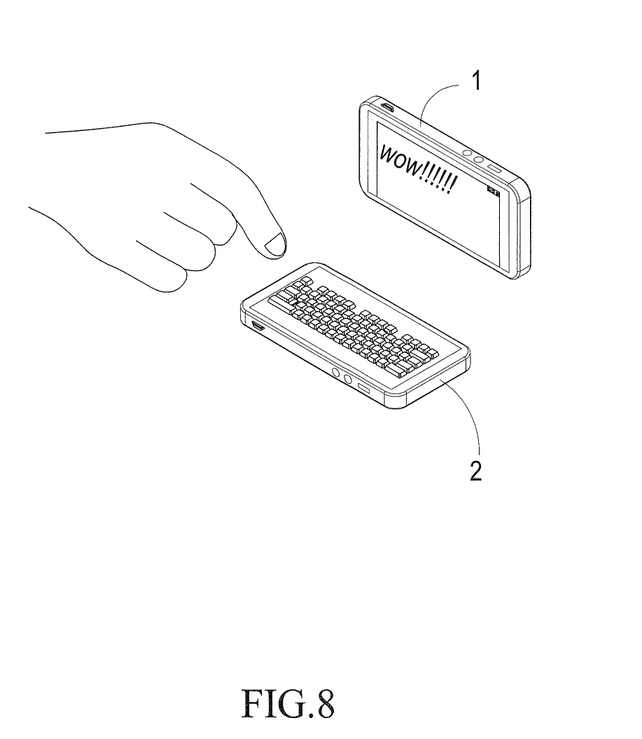

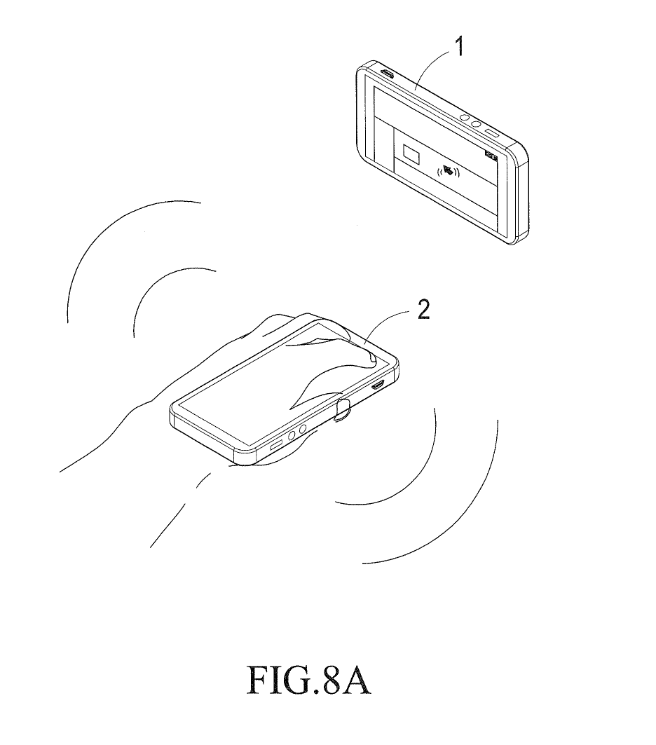

Turning now to FIGS. 8 and 8A, a fourth exemplary application according to the present invention is shown, wherein the first handheld device 1 is employed as a display with its screen, whereas the second handheld device 2 are employed as a keyboard or a mouse with its screen to control the display. In more detail, the first handheld device 1 and the second handheld device 2 are interconnected wirelessly, so that the screen of the second handheld device 2 can be operated as a keyboard to be input with characters, which will be in turn displayed on the screen of the first handheld device 1; similarly, the screen of the second handheld device 2 can be operated as a mouse to control the screen of the first handheld device 1.

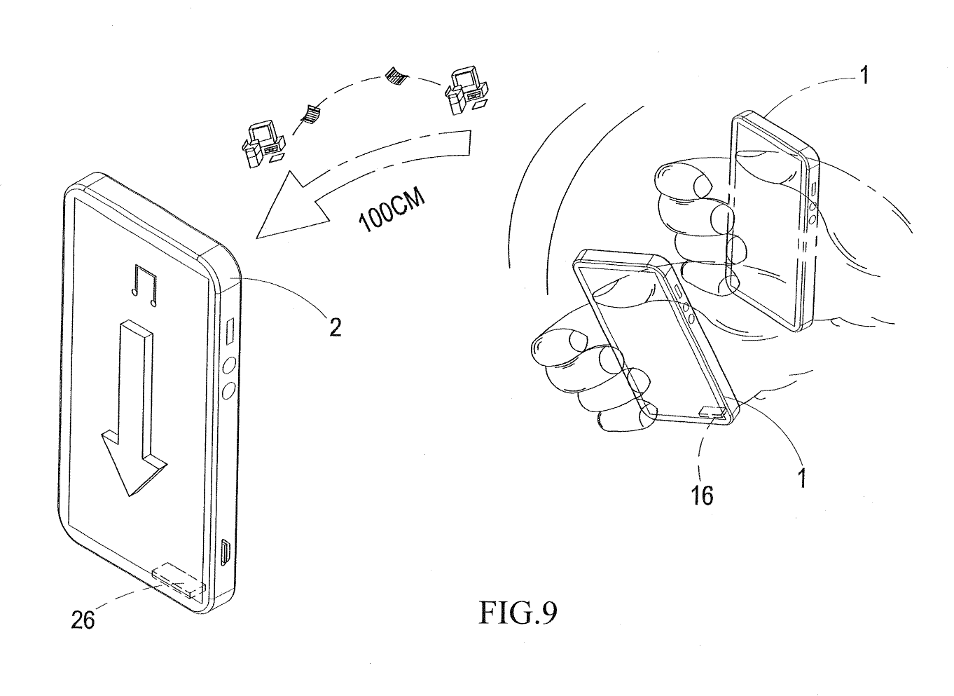

Turning now to FIG. 9, a fifth exemplary application of the present invention is shown, wherein the first handheld device 1 and the second handheld device 2 are each provided with an accelerometer or G-Sensor to detect movement of each handheld device so that each handheld device can be triggered to transmit data wirelessly. In more detail, the first handheld device 1 can be swung to allow the second handheld device 2 to execute the same program or activate the same hardware as the first handheld device 1. For example, when the first handheld device 1 is playing a TV program, a user may swing the first handheld device 1 to allow the second handheld device 2 to play the same program as the first handheld device 1.

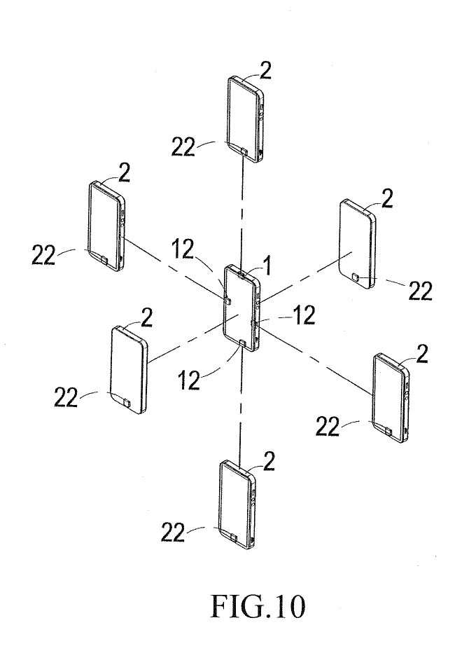

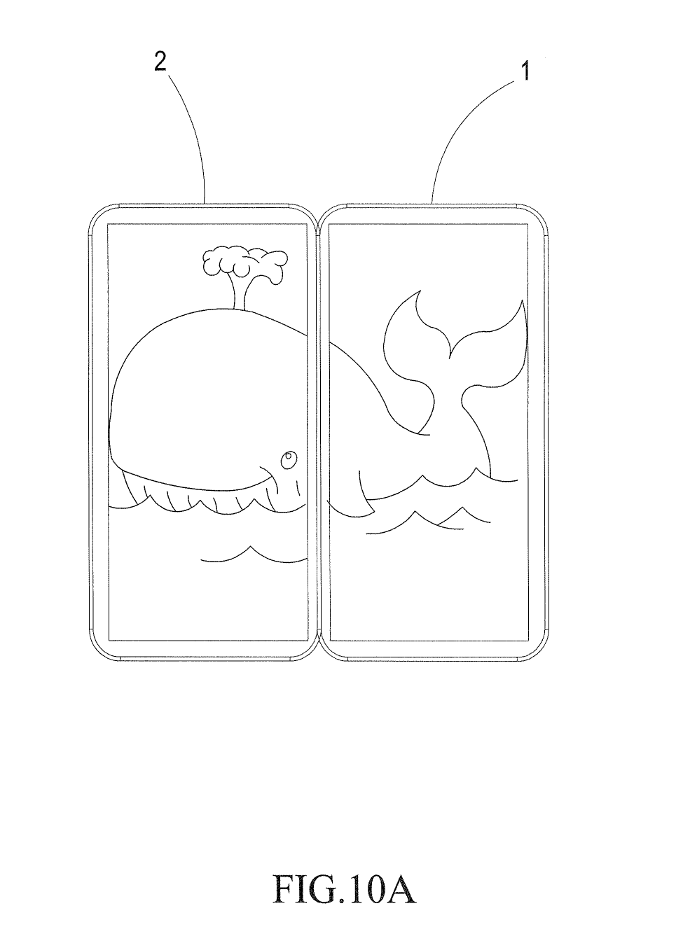

Turning now to FIGS. 10 and 10A, a sixth exemplary application according to the present invention is shown, wherein the first handheld device 1 is provided with a plurality of locking units 11 (not shown) and a plurality of electrical-connecting units 12 respectively at a front side, a rear side and each lateral side thereof. The first handheld device 1 can be combined with at least one second handheld device 2 to form a larger display through the connection between the electrical-connecting unit 12 at a lateral side of the first handheld device 1 and the corresponding electrical-connecting unit 22 of the second handheld device 2.

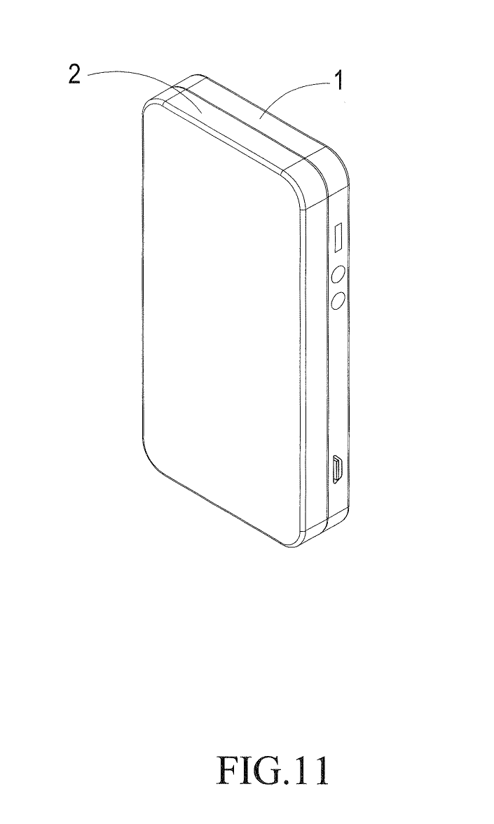

Turning now to FIG. 11, a seventh exemplary application according to the present application is shown, wherein the first handheld device 1 and the second handheld device 2 are combined front by front so as to protect each screen of the handheld devices from being damaged.

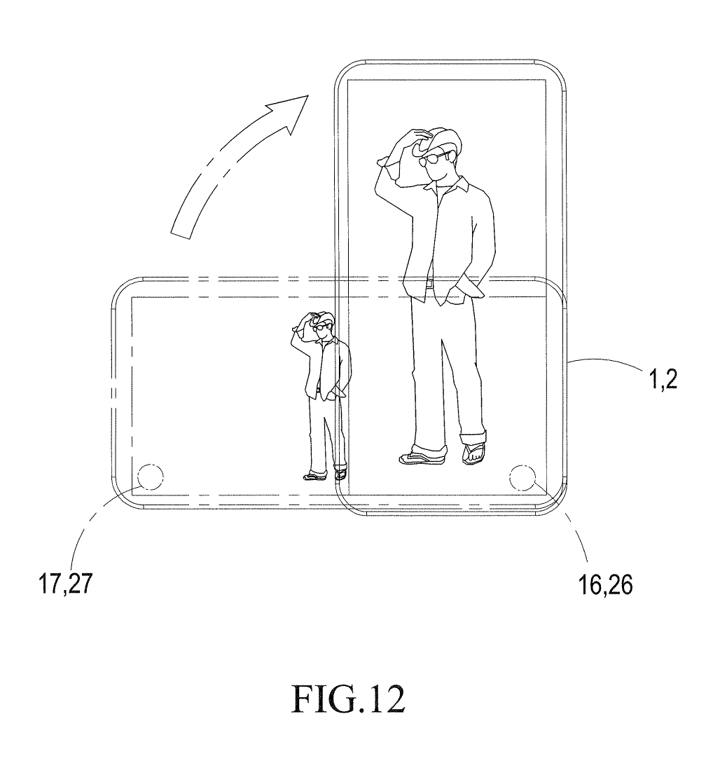

Turning now to FIG. 12, a eighth exemplary application according to the present application is shown, wherein the first handheld device 1 can be provided with an accelerometer 16 and a position sensor 17, the second handheld device 2 can be provided with an accelerometer 26 and a position sensor 27, so that each handheld device can automatically align its screen to represent a landscape or portrait view dependent on the orientation of each handheld device. In more detail, when the first handheld device 1 or the second handheld device 2 is placed from a horizontal direction to a vertical direction, the accelerometer 16 or 26 can detect the change of the weight direction in cooperation with the calculation of a arithmetic unit (not shown) to enable the view on the screen to automatically change from a landscape direction to a portrait direction.

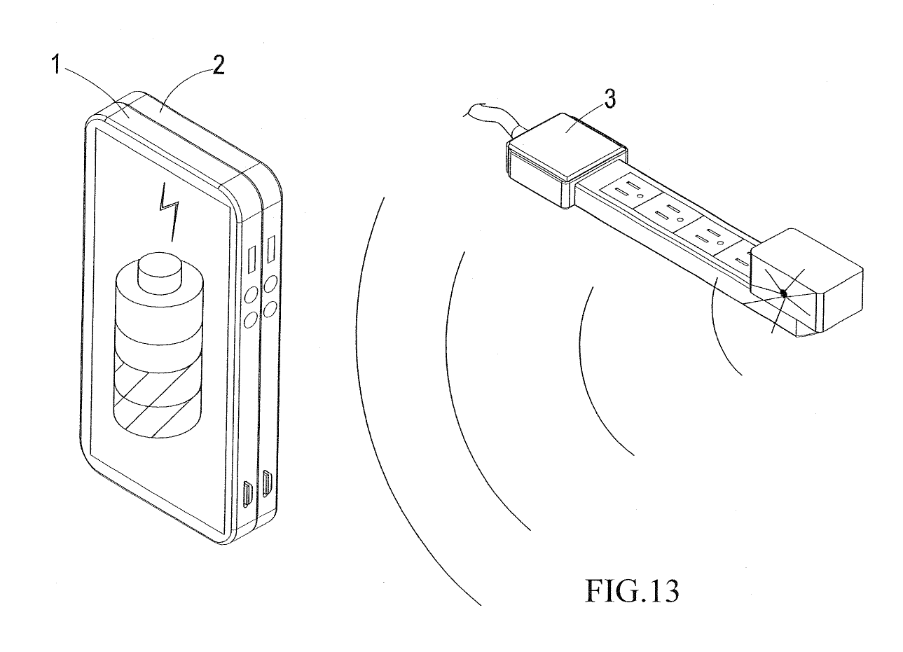

Turning now to FIG. 13, a ninth exemplary application according to the present invention is shown, wherein the first handheld device 1 or the second handheld device 2 can be electrically charged with a wireless charger 3.

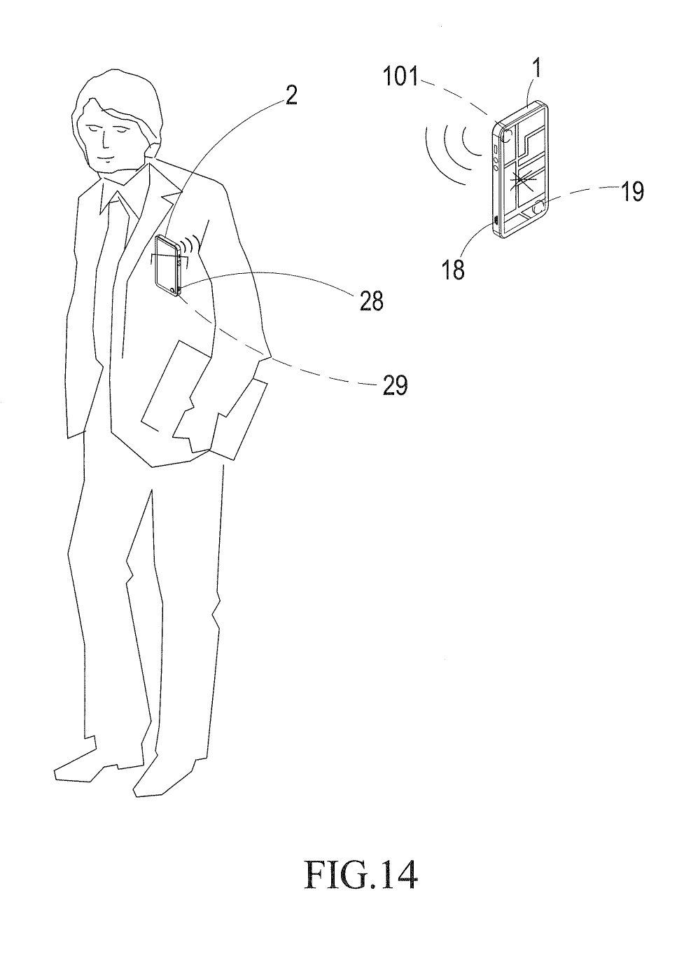

Turning now to FIG. 14, a tenth exemplary application according to the present invention is shown, wherein the first handheld device 1 and the second handheld device 2 are each provided with a distance alerter 18, 28, so that when the first handheld device 1 is away from the second handheld device 2 to reach a predetermined distance, each distance alerter 18, 28 can generate a sound of alarm. The function can be achieved by using the communicational components 101, 201 of the handheld devices 1, 2 in cooperation with the software in the handheld devices 1, 2. The function can prevent old persons and children from going astray. In more detail, the first handheld device 1 and the second handheld device 2 can be respectively provided with signal intensity detectors 19, 29 to determine the distance between the two handheld devices 1, 2 from the intensity of signal so as to achieve the alert function.

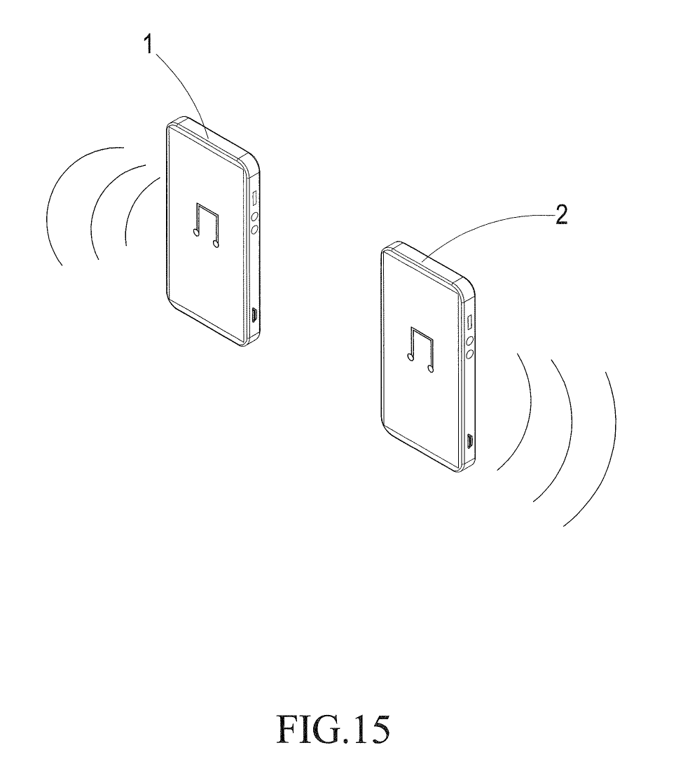

Turning now to FIG. 15, an eleventh exemplary application according to the present invention is shown, wherein the first handheld device 1 and the second handheld device 2 are each provided with a speaker (not shown) so as to create a two-channel stereo sound field when both handheld devices 1, 2 are taken apart. In more detail, the speaker of each handheld device can be operated in cooperation with software in each handheld device to create a two-channel stereo sound field when both handheld devices 1, 2 are taken apart.

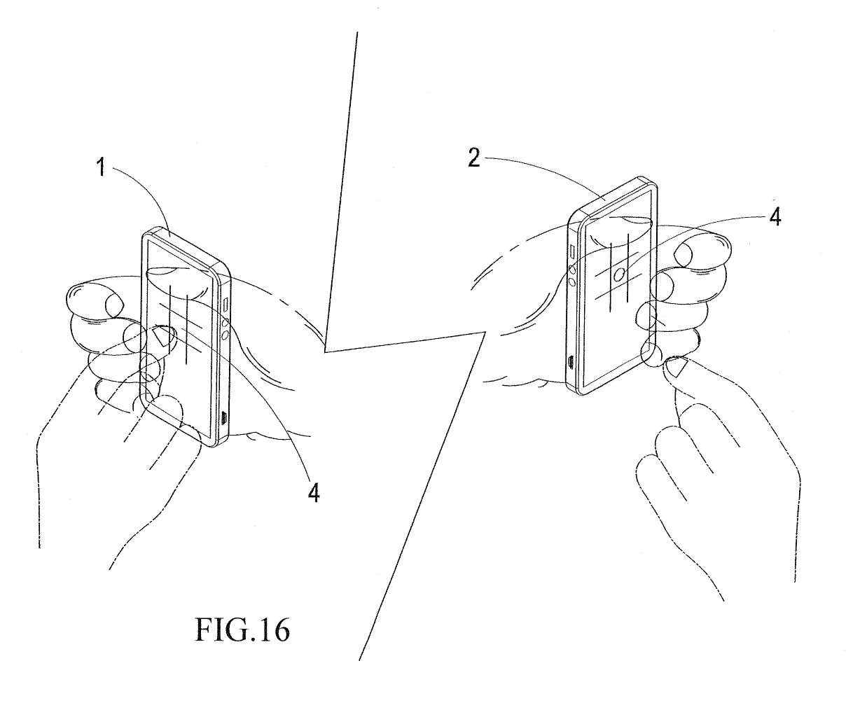

Turning now to FIG. 16, a twelfth exemplary application according to the present invention is shown, wherein the first handheld device 1 and the second handheld device 2 can be employed to play games, such as chess, Chinese chess, gobang, etc, through wireless communication when both handheld devices 1, 2 are taken apart.

Accordingly, the present invention has the following features over prior art:

The first handheld device 1 can cooperate with the second handheld device 2 to share their software resources and hardware resources with each other; the two handheld devices 1, 2 can be operated to receive or dial a call simultaneously; the two handheld devices 1, 2 can be operated individually when they are taken apart; the two handheld devices 1, 2 can be combined together to facilitate portability and operation.

Although the present invention has been described with a certain degree of particularity, it is understood that the present disclosure is made by way of example only and the combination and arrangement of parts may be resorted to without departing from the spirit and scope of the invention hereinafter claimed.

I claim:

1. A portable electronic device comprising:
a first handheld device provided with a locking unit and an electrical-connecting unit on a periphery thereof;
a second handheld device provided with a corresponding locking unit and a corresponding electrical-connecting unit on a periphery thereof, wherein said corresponding locking unit of said second handheld device is capable of interlocking with said locking unit of said first handheld device, said corresponding electrical-connecting unit of said second handheld device is capable of electrically connecting with said electrical-connecting unit of said first handheld device.

2. A portable electronic device comprising:
multiple handheld devices, each of which includes an operational control component and a communicational component electrically connected with said operational control component;
one or more electrical-connecting units provided on one of said multiple handheld devices;
a corresponding electrical-connecting unit provided on each of the others of said multiple handheld devices for electrically connecting with one of said electrical-connecting units so that informational or electrical connection is built for data exchange or power transfer between the two connected handheld devices;
one or more locking units provided on the one of said multiple handheld devices;
a corresponding unit provided on each of the others of said multiple handheld devices for interlocking with one of said locking units.

3. A portable electronic device of claim 1, wherein said first handheld device and said second handheld device each can be a smartphone, a mobile device, or a tablet computer, wherein said smartphone can run an operating system of Apple iOS, Google android, Microsoft Windows Phone OS, Symbian OS, or the like.

4. A portable electronic device of claim 1, wherein said first handheld device and said second handheld device each contains a built-in wireless communication module to allow said first and second handheld devices to communicate with each other without through a base station or a GSM system, wherein said wireless communication module can be of a Wi-Fi module or a wireless ad hoc network module, which cooperates with software in a respective handheld device to conduct communication.

5. A portable electronic device of claim 1, wherein said first handheld device and said second handheld device each can supply power for each other when they are combined together.

6. A portable electronic device of claim 1, wherein said first handheld device and said second handheld device each can share resources with each other, when they are combined together.

7. A portable electronic device of claim 1, wherein said first handheld device and said second handheld device each has software being operated to cooperate with each other, wherein the software can be an operational interface, a telephone directory, a text message, an application program, or a daily routine.

8. A portable electronic device of claim 1, wherein said first handheld device and said second handheld device are each provided with a camera, so that the camera of said first handheld device can transfer image to said second handheld device to be shown on its screen, the camera of said second handheld device can transfer image to said first handheld device to be shown on its screen.

9. A portable electronic device of claim 1, wherein said first handheld device and said second handheld device can be operated in cooperation with each other when they are combined together; said first handheld device and said second handheld device can be operated individually when they are taken apart.

10. A portable electronic device of claim 1, wherein said electrical-connecting unit of said first handheld device and said corresponding electrical-connecting unit of said second handheld device each includes a charging port, which can be a type of a Micro USB or Mini USB charging port, the types of the charging ports may be different to allow a user to have more options in selecting a charger.

11. A portable electronic device of claim 1, wherein said first handheld device can be employed as a display with its screen, whereas said second handheld device can be employed as a keyboard or a mouse with its screen to control the display.

12. A portable electronic device of claim 1, wherein the number of said locking unit and the number of said electrical-connecting unit of said first handheld device is more than one, the locking units and the electrical-connecting units are respectively provided on a front side, a rear side, and each lateral side of said first handheld device; wherein said first handheld device can be combined with at least one said second handheld device to form a larger display through connection of the electrical-connecting units and the corresponding electrical-connecting units; wherein said first handheld device and said second handheld device each can be provided with an accelerometer and a position sensor so that each handheld device can automatically align its screen to represent a landscape or portrait view dependent on its orientation, each handheld device can be triggered to transmit data by using the accelerometer to detect its movement; wherein when said first handheld device and said second handheld device are combined side by side, a larger display can be formed; wherein when said first handheld device and said second handheld device are combined front by front, each screen of said handheld devices can be protected from being damaged; and wherein when said first handheld device and said second handheld device are combined rear by rear, said handheld devices can be operated simultaneously by a user.

13. A portable electronic device of claim 1, wherein said first handheld device can be electrically charged with a wireless charger.

14. A portable electronic device of claim 1, wherein said second handheld device can be electrically charged with a wireless charger.

15. A portable electronic device of claim 2, wherein said locking unit and said corresponding locking unit is a magnetically attaching means or mechanically engaging means so that said locking unit can be interlocked with said corresponding locking unit.

16. A portable electronic device of claim 2, wherein said first handheld device and said second handheld device are each installed with a SIM card, wherein each card can be connected with a different mobile service provider.

17. A portable electronic device of claim 1, wherein said first handheld device and said second handheld device are each provided with a distance alerter, when said second handheld device is away from said first handheld device to reach a predetermined distance, each said distance alerter will generate a sound of alarm.

18. A portable electronic device of claim 1, wherein said first handheld device and said second handheld device are each provided with a speaker so as to create a two-channel stereo sound field when both handheld devices are taken apart.

19. A portable electronic device of claim 1, wherein said first handheld device and said second handheld device are each provided with a signal intensity detector for determining the distance between two said handheld devices from signal intensity.

20. A portable electronic device of claim 1, wherein said first handheld device and said second handheld device can be employed to play games through wireless communication when two said handheld devices are taken apart.

21. A portable electronic device of claim 1, wherein said electrical-connecting unit of said first handheld device is comprised of a first electrical-connecting port, a second electrical-connecting port, and a third electrical-connecting port, wherein said first electrical-connecting port can be electrically connected with a computer, said second electrical-connecting port can be electrically connected with a charger, said third electrical-connecting port can be electrically connected with said second handheld device for informational or electrical transfer between two said handheld devices, said third electrical-connecting port containing a plurality of contacts.

22. A portable electronic device of claim 1, wherein said corresponding electrical-connecting unit of said second handheld device is comprised of a fourth electrical-connecting port, a fifth electrical-connecting port, and a sixth electrical-connecting port, wherein said fourth electrical-connecting port can be electrically connected with a computer, said fifth electrical-connecting port can be electrically connected with a charger, said sixth electrical-connecting port can be electrically connected with said first handheld device for informational or electrical transfer between two said handheld devices, said sixth electrical-connecting port containing a plurality of contacts.

23. A portable electronic device of claim 1, wherein said electrical-connecting unit of first handheld device can be formed into an integral unit capable of connecting with a computer, a charger, and said second handheld device.

24. A portable electronic device of claim 1, wherein said corresponding electrical-connecting unit of second handheld device can be formed into an integral unit capable of connecting with a computer, a charger, and said first handheld device.
